(19) United States
(12) Patent Application Publication
(10) Pub. No.: US 2006/0160059 A1
(43) Pub. Date: Jul. 20, 2006

(54) User education and management system and method

(75) Inventors: Mark William Dompier, Neenah, WI (US); Jayne Louise Gibbon, Appleton, WI (US)

Correspondence Address: SENNIGER POWERS (KCC), ONE METROPOLITAN SQUARE, 16TH FLOOR, ST LOUIS, MO, 63102, US

(73) Assignee: Kimberly-Clark Worldwide, Inc., Neenah, WI (US)

(21) Appl. No.: 11/038,368

(22) Filed: Jan. 19, 2005

(51) Int. Cl. G09B 7/00

(52) U.S. Cl. 434/362

(57) ABSTRACT

A system and method for managing a user. A database includes a record of the user indicating a function to be performed by the user via the system and specifying an access level for the user. An interface monitors the user's training relating to their indicated function and controls whether the user is permitted to execute their indicated function via the system.

### BACKGROUND OF INVENTION

The invention generally relates to a system and method for managing users. In particular, the invention relates to a system and method for controlling the ability of users to perform functions via a system. Further, the invention relates to a system and method which requires employees to be trained on a software module before the employee is permitted to use the software module to perform a job.

Enterprise Resource Planning (ERP) systems which include any business management software such as those offered by SAP, PeopleSoft and Oracle, require extensive training in order for users to gain production access to various functions offered by the software systems. Typically, a user who has been asked to use the ERP system for various job roles must receive proper training for each software component needed to execute the job role. After training, the user is granted security clearance to execute transactions using the respective software components.

Administrators and other managers overseeing education and security for ERP systems face a daunting task of tracking hundreds or perhaps many thousands of users, each of whom may require training and security access for multiple modules of the ERP system. Typically, managers of security and education systems manually track the status of users using spreadsheets or other labor intensive tools. Such tools are prone to many manual errors, tend to be outdated, and are generally unable to track when and why changes in user status were entered. A longstanding, unmet need is simplifying and automating training and security for complex ERP systems, and providing audit trails for changes in the data.

### SUMMARY OF THE INVENTION

In one embodiment, the invention is a system for managing a user. The system comprises a database and an interface. The database includes a record of the user. The record indicates a function to be performed by the user via the system and specifies an access level for the user. The access level defines whether the user is permitted execute their indicated function via the system. The interface monitors the user's training relating to their indicated function; modifies the user's access level to correspond to the user's training; and controls according to the user's specified training whether the user is permitted to execute their indicated function via the system.

In another embodiment, the invention is a system for controlling the ability of users to perform functions. The system comprises a database including a record of each user and an interface. Each record indicates a job role of each user, each job role having a function to be performed by each user. Each user employs a software module corresponding to their function to perform their function. Each record also specifies an access level for each user. The access level defines whether the user is permitted use the corresponding software module to perform their function. The interface monitors each user's training relating to the software module corresponding to their function; modifies each user's access level to correspond to their monitored training; and controls according to each user's specified training whether each user is permitted to access the software module corresponding to their function to execute their function.

In another embodiment, the invention is a method for managing a user. The method comprises:

Maintaining a record for each user, the record indicating a function to be performed by the user via a system and specifying an access level for the user, said access level defining whether the user is permitted execute their indicated function via the system;

monitoring the user's training relating to their indicated function;

modifying the user's access level to correspond to the user's training; and

controlling according to the user's specified training whether the user is permitted to execute their indicated function via the system.

In another embodiment, the invention is a computer-assisted method for managing user access rights in an ERP system having multiple software modules. The method comprises:
a) identifying a job role of a user related to the ERP system;
b) identifying the software modules in the ERP system to be used to perform the job role;
c) identifying the respective training required before a user can be granted access to each software modules pertaining to the job role;
d) in response to the user completing the training for one of the software modules pertaining to the job role, generating a message a human security supervisor and/or an electronic security management tool requesting user access to the software module for which training has been completed;
e) granting user access to the software module for which training has been completed; and
f) updating a database containing information about users, job roles of users, and software modules associated with job roles, such that the information in the database indicates that the user has been granted access to the software module for which training has been completed.

Other objects and features will be in part apparent and in part pointed out hereinafter.

### BRIEF DESCRIPTION OF THE DRAWINGS

FIG. 1 is a block diagram of one embodiment of a system according to one embodiment of the invention for monitoring user training and controlling user access to a platform which the user utilizes to execute a function.

FIG. 2 is a block diagram of one embodiment of a system according to one embodiment of the invention for monitoring user training and controlling user access to an ERP (Enterprise Resource Planning) system which the user utilizes to execute a function (e.g., authorizing requisitions via a budget review module) which is part of the user's job role.

FIG. 3 illustrates a flow chart used to determine the access level of a particular administrator/user according to one embodiment of the invention.

FIG. 4 illustrates the flow diagram of the process of a user identifying and reviewing a particular course or other training that needs to be accomplished as part of the user's job role according to one embodiment of the invention.

Corresponding reference characters indicate corresponding parts throughout the drawings.

### DETAILED DESCRIPTION OF THE INVENTION

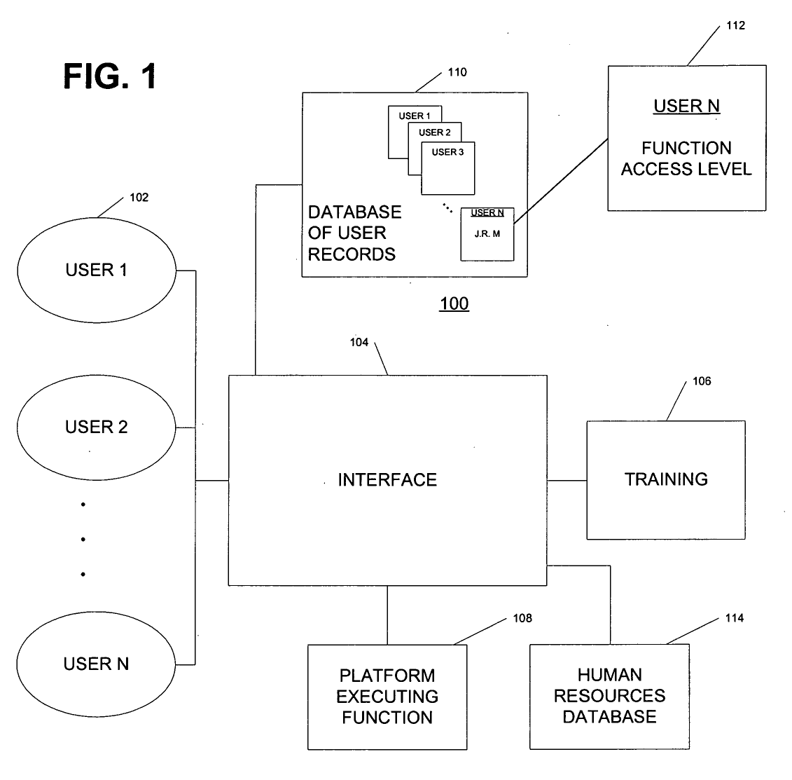

The invention comprises an education management system and method for managing education and security assignments for large numbers of users such as users of ERP systems. FIG. 1 is a block diagram of one embodiment of a system 100 according to the invention for monitoring user training and controlling user access to a platform which the user utilizes to execute a function. A number of users such as N users 102 utilize an interface 104 (e.g., a graphical or other user interface) to access training 106 and a platform 108 for executing particular functions. The interface 104 is connected to a database 110 including user records 112. Each user record 112 specifies at least one function for a user and an access level for the user. The access level or security assignment level indicates the function or functions which a user is permitted to perform on the platform 108. In other words, the access level defines whether the user is permitted to execute their indicated function or functions. The interface 110 monitors the training of each of the users 102 relating to their particular function. For example, a user 102 may access training 106 in order to learn how to perform a particular function which is executed on platform 108. After the user completes the particular training 106, interface 104 accesses the user's record in database 110 and modifies the access level of the user to indicate that the user has completed the necessary training and is permitted to have production access the platform to execute the function. The interface 104 controls the user's access to the platform 108 according to the access level specified in the user's record 112. Thus, the interface controls whether the user is permitted to execute their indicated function on platform 108 according to the user's access level as specified in the user record 112.

In general, each user is required to complete certain training 106 in order to execute their indicated function or functions. The production access level of each user corresponds to the training completed by the user so that the production access level indicates which functions the user is permitted to execute. Thus, the user can only execute their indicated function after completing the training for that particular function. In one embodiment, the interface 104 may be connected to a human resources database 114 including information about each user. The interface 104 utilizes the information about the user in the human resources database 114 to verify the user's identity. This ensures that the user cannot enter a phony identification. Precise tracking of user information and identity, coupled with user authentication, is possible through accessing the human resources database 114 for these purposes. By incorporating the extensive information in the human resources database 114 regarding locations, departments, cost centers, etc., the system 100 and method of the invention can filter its database by many other factors such as by department, location, Hay point level (based on the widely used Hay Guide Chart-Profile Method of Job Evaluation of the Hay Group, Inc., Philadelphia, Pa.) or other systems related to job function, etc., allowing the information of the system 100 to be displayed and grouped in many ways. As a result, the interface 104 is connected to the human resources database 114 which includes information about the user so that the interface 104 can use the information about the user in the human resources database to verify the user's identity.

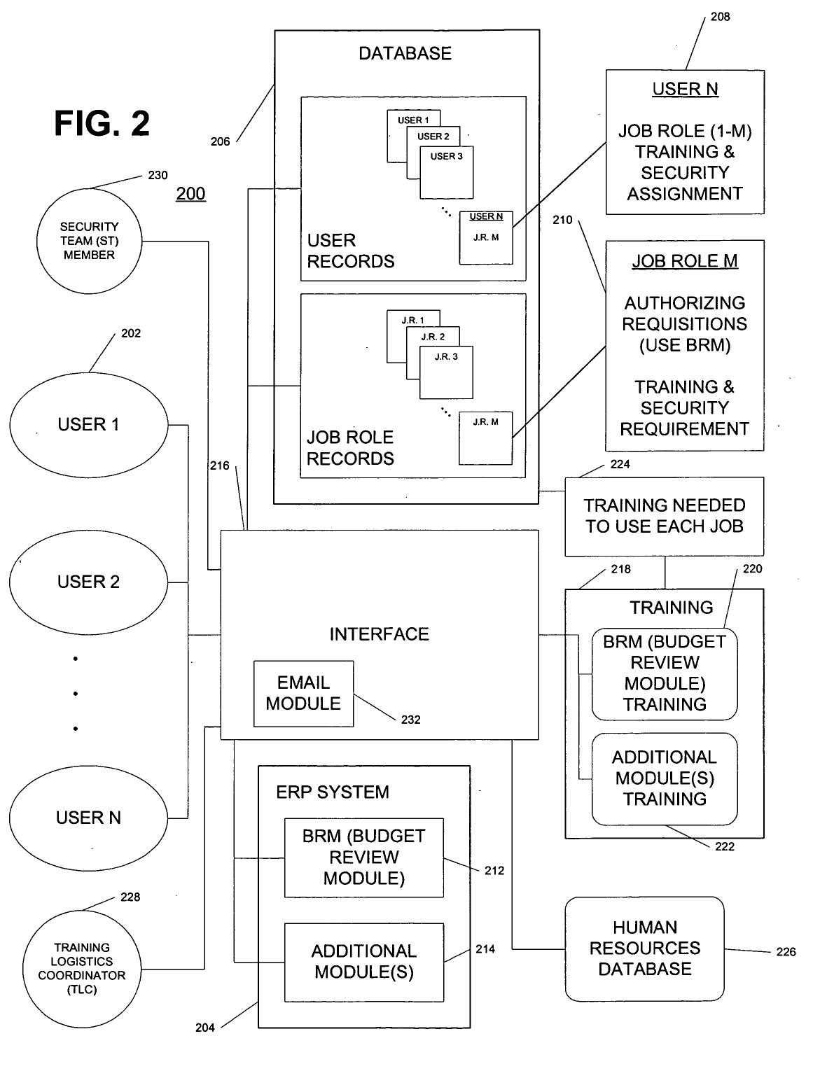

Referring to FIG. 2, a block diagram is illustrated of one embodiment of a system 200 according to the invention for monitoring user training and controlling user access of an ERP (Enterprise Resource Planning) system which the user utilizes to execute a function. Among other things, this system 200 addresses the problem of managing education and security assignments for a large number of users of ERP systems. In other words, system 200 of FIG. 2 controls the ability of users 202 to perform functions via an ERP system 204. The system 200 includes a database 206 including a record 208 for each user. The record 208 indicates a job role of each user. The database also includes job role records 210, each record specifying a function to be performed by each user who has been assigned a particular job role. In general, each user would employ one or more software modules of the ERP system 204 to perform the function. For example, the ERP system 204 may include a software module such as a budget review module (BRM) 212 or additional modules 214 which are utilized by the user to perform various functions.

Each user record 208 would specify an access level or a security assignment level defining whether the user is permitted to have production access the corresponding software module to execute the necessary function of the user's job role. Optionally, the user record 208 may also include a list of training which the user has completed.

Users 202 would access the system 200 via interface 216 which would monitor each user's training relating to the software module corresponding to their job role and function. For example, a training system 218 may be available to the user to train the user on the various modules of the ERP system 204. As illustrated in FIG. 2, training 218 would include a BRM training 220 and additional module training 222 corresponding to training for each of the modules of the ERP system 204. Interface 216 is connected to the database 206 and modifies each user's access level of the user record 208 according to the amount of training that the user has completed. Interface 216 controls whether the user is permitted to use a particular module of the ERP system 204 according to the user's specified training or security assignment as indicated in the user's record 208. In other words, interface 216 controls whether or not the user can perform a particular function based on whether or not the user has been trained to use a module which executes that function.

The system 200 may have an optional database 224 indicating the training needed to use each module. Database 224 would be used to provide information which would indicate the training needed for each module utilized for each function of each job role. The needed training may be entered as part of the job role record 210. As a simple example, database 224 may indicate that a user must complete the BRM training 220 in order to use the BRM 212 of the ERP system 204 to perform the function of authorizing requisitions. According to the job role 210, authorizing requisitions is part of the job role function and would require the use of the BRM 212. Thus, job role 210 would indicate the users having this job role need to complete the BRM training 220. When a user completes the BRM training 220, the user's access level or security assignment as indicated by the user record 208 would be updated to indicate that this training has been completed. As a result, interface 216 would permit the user to have production access to the BRM 212 of the ERP system 204 in order to perform the function of authorizing requisitions.

In this simple example, a single training (BRM training 220) is needed in order to use BRM 212 to perform the function of authorizing requisitions. In general, it is contemplated that a particular function may require the use of several modules. Furthermore, it is contemplated that the ability to use a particular module may require the completion of several different types of training. Thus, the system 200 is configured in order to permit the user to complete the necessary training in order to get production access to the necessary modules in order to perform the function of the user's job role.

In one form, the database 206 may be an SQL database containing records associated with every user with one or more job roles, training information and security status. Each job role is associated with a description of the job and with information about the various software modules needed for the job role. Each software module is associated with information about the training course or courses that must be completed to obtain an authorization (security clearance) for use of the software module. As noted above, this information may also be stored in the database 224 which may be separate from or integrated with database 206.

In the specific example of FIG. 2, the job roles refer to jobs that are executed using the ERP system 204. In the example noted above, a job role may be “requisition approver” which refers to the role of authorizing requisitions. This job role may require training regarding several different types of transactions and one or more software modules to handle these transactions. Security clearance to approve requisitions will not be granted until the user has completed all training required for all software modules which are used to authorize requisitions or otherwise used as part of the requisition approver job role. Security clearance to approve requisitions will not be granted until the user has completed all training for the job role. Preferably, the user must complete all training for a specific job role. The system keeps track of training needs on a job-by-job basis. If a user has multiple job roles, the system will grant production access to a user once all training is complete the particular job role, even though the user may have to complete other training in order to have production access to other job roles. Thus, the user does not need to complete all training for all jobs to get access to a component of the ERP system. Optionally, information about such roles and associated training is linked to user information in the database 206.

Users in a given location are assigned job roles by administrators for that given location. Standardized job roles are used that pertain to their activities in the ERP system 204. The assignment of users to jobs is generally a one-to-many assignment.

Database 206 linking users, job roles, training needs, training status and security assignment status can be filtered in numerous ways. For example, a manager may quickly display education status and security assignment status for all employees in a particular group. Alternatively, a security manager may filter the database 206 to display only information for a particular software module or job role. Filtering may be done to show only employees who have not completed training for one or more software modules or to show employees who have been asked to complete training on or before a given date (e.g., over one month without having completed the requested education).

When a user 202 is assigned a job and the user's record 208 is modified to reflect this, the user 202 gains access to the training system 218, allowing the user to take the needed training. At this point, production access to the job role is not provided to the user until training is completed. The user has the ability to execute their function in training as soon as the training logistics coordinator assigns the job role. Only upon completion of the training does the user get the right to have production access.

In one embodiment, a training logistics coordinator 228 can manually enter information in a user's record 208 when training is completed. Also, at that point, an email can then be manually or automatically sent to request a security assignment for the particular user. In general, the system includes an email module 232 for sending an email to a user and/or an administrator overseeing the user when the user's access level changes or when the user's training requirement changes. More generally, email and any other form of communication can be used in a notification module to send information regarding changes in a user's training status. Such forms of communication can include instant messaging, automatically generated voice mail, printed messages, other alerts, etc.

A security team member 230 would then enter new security updates for the user by modifying the user's record 208. Alternatively, the granting of a security assignment after training could be completed automatically. However, it has been found that human oversight may be desirable. When the security clearance for a particular user is modified so that the user is authorized to use a particular module of the ERP system 204, an audit trail of any changes to a record may be maintained. For example, a separate record may be created as part of the database 206 or as part of another database indicating when the security assignment status of the particular user was changed and who changed the record. If desired, the system can also be adapted such that reasons can be entered as comments or codes when a change in status is made. When a change in status of a user is entered, the system may automatically issue an email to appropriate parties indicating the change in status and identifying what actions may be needed, if any. For example, security authorizers may receive an email automatically indicating that a logistics coordinator has added a job role for a specific user. The email will indicate what the current and added security roles are. This avoids the need for manually updating security roles for thousands of users on a regular basis.

As noted in FIG. 2, interface 216 may be connected to a human resources database 226 to increase security and minimize the possibility of a user entering a phony identification. Information from the human resources database 226 allows precise tracking of user information and user identity so that users can be authenticated through the information in the database 226. In addition, by incorporating the information in the human resources database 226 (such as location, department, cost center, etc.) in the authentication process, the system 200 can filter its database 206 by many other factors such as location, department, Hay point level, etc., allowing the system 200 to display information or to group information in many different ways.

One advantage of the system is the improved ability to display information in terms that are readily understood by those operating the business. In some prior art systems, extracted information would be displayed in terms of arcane codes. The system 200 allows a manager to see information such as job roles in terms of more understandable descriptors such as system buyer or requisition approver.

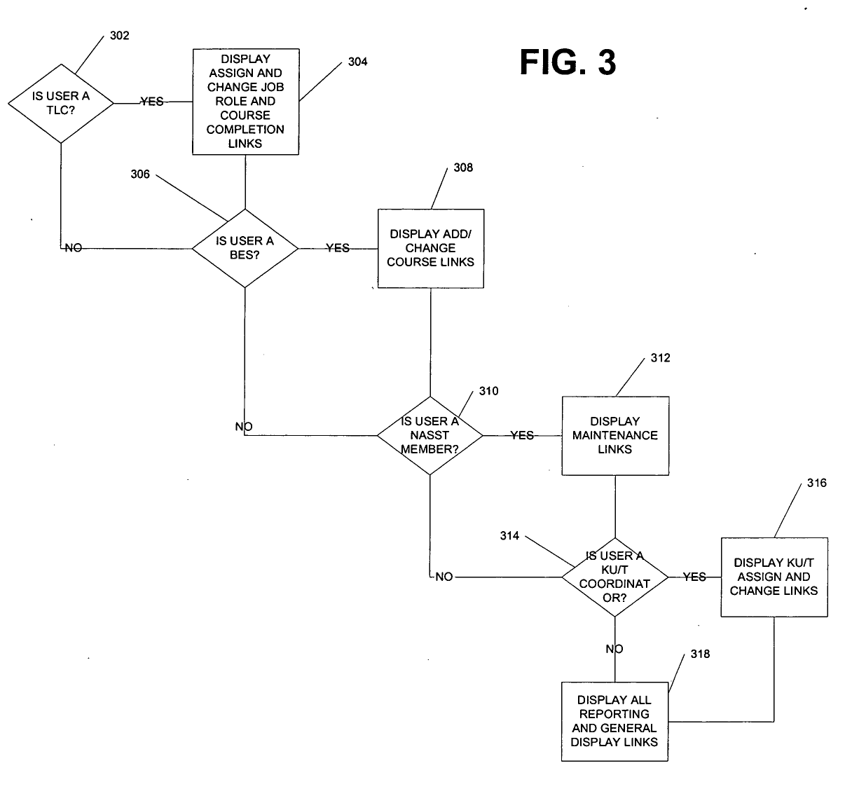

It is contemplated that various users and administrators would have various levels of authority to use the system 200 and to modify the information of system 200. For example, FIG. 3 illustrates a flow chart used to determine the access level of a particular administrator/user. At 302, it is determined whether a user is a training logistics coordinator (TLC). If the user is a training logistics coordinator, the user is directed to a display of the assign and change job role and course completion links at 304. Whether or not the user is a training logistics coordinator, it is determined at 306 whether the user is a business education specialist (BES). If the user is a business education specialist, the user is directed to a display of add/change course links at 308. Whether or not the user is a BES, it is determined at 310 whether the user is a security team (ST) member. If the user is an ST member, the user is directed to a display of maintenance links at 312. Whether or not the user is a ST member, it is determined at 314 whether the user is a key user/trainer (KU/T) coordinator. If the user is a KU/T coordinator at 314, then the user is directed to a display of KU/T assign and change links at 316. Whether or not the user is KU/T coordinator, the user is directed to a display of all reporting and general display links at 318.

In one embodiment, the levels of authority noted above would have the following duties and responsibilities:

KU/T—Key User/Trainer. The Key User/Trainers train and support the ERP implementation. The KU/T Coordinator has the ability to assign KU/T roles to users (these roles are “super” job roles, as they have additional access so that the trainer can troubleshoot, and do additional master data efforts).

TLC—Training Logistics Coordinator. The TLC has the ability to assign job roles and enter course completions for individuals.

BES—Business Education Specialist. The BES has the ability to add/change course information and also request course deletions.

NASST—North American SAP Security Team. The NASST has access to all master data maintenance screens (deleting employees, adding TLCs, changing job role information, etc).

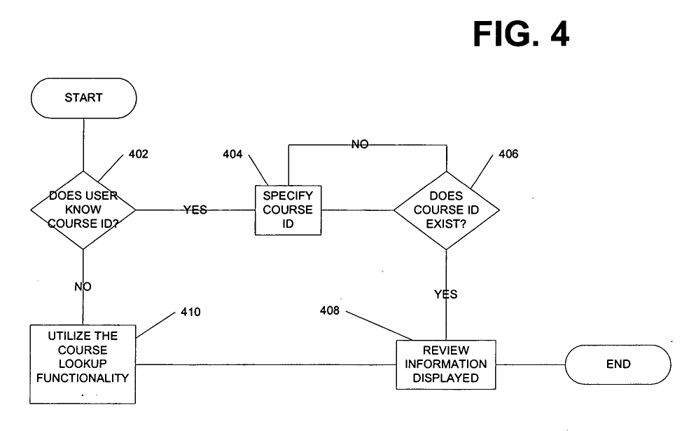

FIG. 4 illustrates the flow diagram of the process of a user identifying and reviewing a particular course or other training that needs to be accomplished as part of the user's job role. At 402, it is determined whether the user knows the course ID. If so, the user specifies the course ID at 404 and the existence of the course is confirmed at 406 at which point the user is permitted to review the course information at 408. If the user does not know the course ID, the user is directed to utilize the course look up functionality at 410. Once the user identifies the course, the user is directed to 408 to review the course information. When the user completes the review of the course information, and optionally passes one or more tests, the information in the database (110, 206) of the system (100, 200) is updated to reflect that the user has completed this aspect of training. Automating the process is an option. However, due to E-Signature requirements, paper copies may be maintained of rosters which are entered into the system by the TLC. A email may be generated, either manually or automatically, to reflect that the user completed the training and to reflect any changes to the user's security level.

As described above, the invention includes a method for managing a user. The method includes:

maintaining a record for each user, the record indicating a function to be performed by the user via a system and specifying an access level for the user, the access level defining whether the user is permitted execute their indicated function via the system;

monitoring the user's training relating to their indicated function;

modifying the user's access level to correspond to the user's training; and

controlling according to the user's specified training whether the user is permitted to execute their indicated function via the system.

The method also includes requiring user to complete certain training in order to execute their indicated function wherein the access level of the user corresponds to the training completed by the user so that the user can only execute their indicated function in production after completing the training for the function.

The method also includes connecting the interface to a human resources database including information about the user wherein the interface utilizes the information about the user in the human resources database to verify the user's identity.

The method also includes associating each software module with information about the training needed in order to use the software module wherein the user has access to the information.

The method also includes filtering by an administrator of the database to display at least one of the following: users and their access level, information for a particular software module or job role, users who have not completed training for a software module.

The method also includes assigning a user a job and providing the user with access to a software module for executing the assigned job so that access to the job role is not available until training is complete.

The method also includes maintaining an audit trail of changes to the record.

The method also includes using an email module to send an email to a user and/or an administrator overseeing the user when the user's access level changes or when the user's training requirement changes.

In one embodiment, the invention includes a method for managing user access rights in an ERP system having multiple software modules. In particular, the method includes:
a) identifying a job role of a user related to the ERP system;
b) identifying the software modules in the ERP system to be used to perform the job role;
c) identifying the respective training required before a user can be granted access to each software modules pertaining to the job role;
d) in response to the user completing the training for one of the software modules pertaining to the job role, generating a message a human security supervisor and/or an electronic security management tool requesting user access to the software module for which training has been completed;
e) granting user access to the software module for which training has been completed; and
f) updating a database containing information about users, job roles of users, and software modules associated with job roles, such that the information in the database indicates that the user has been granted access to the software module for which training has been completed.

The method also includes identifying the software modules in the ERP system to be used to perform the job role comprises accessing the database to retrieve information about the software modules.

The method also includes that at least one of steps (a), (b), and (c) comprises accessing a graphical user interface comprising a Web-based display of information obtained from the database.

The method also includes storing information in the database about the training completed by the user and the date on which the user was granted production access to the software module.

An Appendix filed with the application illustrates various screen shots of one embodiment of the invention. FIG. A-1 (see Appendix) illustrates that the Job Role Assignment section and the Maintenance sections are fully expanded, as the EMS recognizes the user as both a TLC and a maintenance user. FIG. A-2 (see Appendix) illustrates that the EMS knows the locations to which the user (Mark) has access in order to assign job roles. As you can see in the example of FIG. A-2 (see Appendix), Mark is listed as a TLC for Neenah, Jenks and Beech Island. FIG. A-3 (see Appendix) illustrates that the TLC specifies the ID of the employee listed at the Jenks facility. For this example, Mark's ID is listed as a Jenks employee. FIG. A-4 (see Appendix) illustrates the Assignment (screen cap 1). FIG. A-5 (see Appendix) illustrates the Assignment (screen cap 2). FIG. A-6 (see Appendix) illustrates a Summary (screen cap 1) and FIG. A-7 (see Appendix) illustrates a Summary (screen cap 2). FIG. A-8 (see Appendix) illustrates the Display job role assignments for Mark (previously assigned job role 2).

FIG. A-9 (see Appendix) illustrates the Job role assignments listed. A hyperlink allows the user to easily access detailed job role information. FIG. A-10 (see Appendix) illustrates the Detailed job role information maintained in the EMS, including description, key tasks, POLARIS Manufacturing Process, training courses and security requirements.

Exemplary information about the interfaces and software modules of ERP systems is provided in the following: U.S. Pat. No. 5,768,586, issued Jun. 16, 1998 to Zweben and Deale; U.S. Pat. No. 6,407,761, issued Jun. 18, 2002 to Ching et al.; U.S. Pat. No. 6,750,766, issued Jun. 15, 2004 to Heitner et al.; U.S. Pat. No. 6,430,563, issued Aug. 6, 2002 to Fritz et al.; and U.S. Pat. No. 6,714,914, issued Mar. 30, 2004 to Peters et al., each of which is herein incorporated by reference in their entireties to the extent they are non-contradictory herewith.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above systems and methods without departing from the scope of the invention, it is intended that all matter contained in the above description and shown in the accompanying drawings shall be interpreted as illustrative and not in a limiting sense.

What is claimed is:

1. A system for managing a user, said system comprising:
A database including a record of the user, the record:
indicating a function to be performed by the user via the system; and
specifying an access level for the user, said access level defining whether the user is permitted execute their indicated function via the system; and
An interface:
monitoring the user's training relating to their indicated function;
modifying the user's access level to correspond to the user's training; and
controlling according to the user's specified training whether the user is permitted to execute their indicated function via the system.

2. The system of claim 1 wherein the user is required to complete certain training in order to execute their indicated function and wherein the access level of the user corresponds to the training completed by the user so that the user can only execute their indicated function in production after completing the training for the function.

3. The system of claim 1 wherein the interface is connected to a human resources database including information about the user and wherein the interface utilizes the information about the user in the human resources database to verify the user's identity.

4. The system of claim 1 wherein each software module is associated with information about the training needed in order to use the software module and wherein the user has access to the information.

5. The system of claim 1 wherein an administrator can filter the database to display at least one of the following: users and their access level, information for a particular software module or job role, users who have not completed training for a software module.

6. The system of claim 1 wherein a user is assigned a job and is provided with access to a software module for executing the assigned job so that access to the job role is not available until training is complete.

7. The system of claim 1 further comprising an audit trail of changes to the record.

8. The system of claim 1 further comprising an email module for sending an email to a user and/or an administrator overseeing the user when the user's access level changes or when the user's training requirement changes.

9. A system for controlling the ability of users to perform functions, said system comprising:
A database including a record of each user, each record:
indicating a job role of each user, each job role having a function to be performed by each user wherein each user employs a software module corresponding to their function to perform their function; and
specifying an access level for each user, said access level defining whether the user is permitted to use the corresponding software module to perform their function; and
An interface:
monitoring each user's training relating to the software module corresponding to their function;
modifying each user's access level to correspond to their monitored training; and
controlling according to each user's specified training whether each user is permitted to access the software module corresponding to their function to execute their function.

10. The system of claim 9 wherein each software module is associated with information about the training needed in order to use the software module and wherein each user has access to the information.

11. The system of claim 9 wherein an administrator can filter the database to display at least one of the following: users and their access level, information for a particular software module or job role, users who have not completed training for a software module.

12. The system of claim 9 wherein a user is assigned a job of their job role and is provided with access to a software module for executing the assigned job so that production access to the job role is not available until training is complete.

13. The system of claim 9 wherein the user is required to complete certain training in order to execute their indicated function and wherein the access level of the user corresponds to the training completed by the user so that the user can only execute their indicated function after completing the training for the function.

14. The system of claim 9 wherein the interface is connected to a human resources database including information about the user and wherein the interface utilizes the information about the user in the human resources database to verify the user's identity.

15. The system of claim 9 further comprising an audit trail of changes to the record.

16. The system of claim 9 further comprising an email module for sending an email to a user and/or an administrator overseeing the user when the user's access level changes or when the user's training requirement changes.

17. A method for managing a user, said method comprising:
Maintaining a record for each user, the record indicating a function to be performed by the user via a system and specifying an access level for the user, said access level defining whether the user is permitted to execute their indicated function via the system;
monitoring the user's training relating to their indicated function;
modifying the user's access level to correspond to the user's training; and
controlling according to the user's specified training whether the user is permitted to execute their indicated function via the system.

18. A computer-assisted method for managing user access rights in an ERP system having multiple software modules, the method comprising:
a) identifying a job role of a user related to the ERP system;
b) identifying the software modules in the ERP system to be used to perform the job role;
c) identifying the respective training required before a user can be granted access to each software modules pertaining to the job role;
d) in response to the user completing the training for one of the software modules pertaining to the job role, generating a message a human security supervisor and/or an electronic security management tool requesting user access to the software module for which training has been completed;
e) granting user access to the software module for which training has been completed; and
f) updating a database containing information about users, job roles of users, and software modules associated with job roles, such that the information in the database indicates that the user has been granted access to the software module for which training has been completed.

19. The method of claim 18, wherein identifying the software modules in the ERP system to be used to perform the job role comprises accessing said database to retrieve information about the software modules.

20. The method of claim 18, wherein at least one of steps (a), (b), and (c) comprises accessing a graphical user interface comprising a Web-based display of information obtained from said database.

21. The method of claim 18, further comprising storing information in the database about the training completed by the user and the date on which the user was granted production access to the software module.
